(19) United States
(12) Patent Application Publication
(10) Pub. No.: US 2008/0198113 A1
(43) Pub. Date: Aug. 21, 2008

(54) Driving method for reducing response time of twisted nematic liquid crystal displays and super twisted nematic liquid crystal displays

(75) Inventors: Shi-Ming Cheng, Tainan City (TW); Huai-Yi Hsu, Taipei County (TW)

Correspondence Address: Joe McKinney Muncy, PO Box 1364, Fairfax, VA, 22038-1364, US

(73) Assignee: Sitronix Technology Corp.

(21) Appl. No.: 11/707,881

(22) Filed: Feb. 20, 2007

(51) Int. Cl. G09G 3/36

(52) U.S. Cl. 345/88

(57) ABSTRACT

The present invention discloses a driving method for reducing the response time of TN LCD and STN LCD, wherein a dynamic picture judgment mechanism is arranged behind the RGB data bus and used to compare the current picture with the previous picture; if the pictures are different, an over-driving compensation voltage is output N times within each refresh time of the data bus, and the over-driving compensation voltage is flexibly higher or lower than the original output voltage. Thereby, the liquid crystal can twist to attain the target brightness within a shorter time. Therefore, the present invention can solve the problem of the blurring phenomenon resulting from a too long response time of PM-LCD (such as TN LCD and STN LCD).

### FIELD OF THE INVENTION

The present invention relates to a passive matrix-LCD driving technology, particularly to a driving method for TN LCD and STN LCD, which can effectively shorten the response time of liquid crystal and improve the blurring phenomenon of dynamic pictures.

### BACKGROUND OF THE INVENTION

As LCD (Liquid Crystal Display) has the advantages of slimness, compactness and lightweight and consumes less power than the conventional CRT (Cathode Ray Tube), LCD has been gradually replacing CRT recently.

According to the driving methods, the flat-panel liquid crystal display (LCD) may be divided into the passive matrix LCD (PM-LCD) and the active matrix LCD (AM-LCD). In PM-LCD, X-direction transparent ITO (Indium Tin Oxide) electrodes and Y-direction transparent ITO electrodes are respectively formed on two glass plates, and one glass plate is superimposed over the other one with liquid crystal filled therebetween. The intersections of the X-direction electrodes and the Y-direction electrodes are the pixels of LCD. External driving voltage is applied between the X-direction electrodes and the Y-direction electrodes to enable the rotation of liquid crystal molecules.

In AM-LCD, each pixel has a switch element (TFT, Thin Film Transistor) and a complementary capacitor (Cst), and each pixel is independently driven by the elements on the pixel. In AM-LCD, thin film transistors are formed on the panel; therefore, AM-LCD is also called TFT-LCD (Thin Film Transistor Liquid Crystal Display).

Refer to FIG. 1 a diagram schematically showing the architecture of an m×n PM-LCD. The pixels 1 of a PM-LCD, such as a TN (Twisted Nematic) LCD or an STN (Super Twisted Nematic) LCD, are not controlled by non-linear elements. The pixels 1 of a PM-LCD are the intersections of the horizontal routings of common electrodes 2 and the vertical routings of segment electrodes 3. In principle, the electro-optical effect of liquid crystal, which is generated by the RMS (Root Mean Square) values of the applied voltage, is used in the operation of PM-LCD. The response time of liquid crystal must be much longer than the scanning period of the driving pulse. If the frame rate is 60 Hz, the active time of each horizontal scanning line (the common electrode 2) will be 16.67 ms, and the response time of liquid crystal is generally 200 ms, which is the necessary condition that liquid crystal responds to the RMS values.

However, image streaking will appear in the dynamic pictures of the LCD adopting the traditional APT (Alt & Pleshko Theory) driving method because liquid crystal responds too slowly. If LCD adopts a fast-response liquid crystal, the pictures will have flicker, and the contrast will be greatly reduced.

Refer to FIG. 2 a block diagram schematically showing the LUT (LookUp Table) operation of a general over-driving circuit. A general solution of the abovementioned problem is assigning different over-driving voltages V′ to different pictures, wherein a picture-judgment circuit 10 has a comparing device 12, and the comparing device 12 compares a current field with the previous field, which is stored in the storage device 11 inside or outside the picture-judgment circuit 10. If the pictures are different, they are dynamic pictures. Then, a LUT circuit 13 looks up a table to determine an appropriate over-driving voltage value and outputs the over-driving voltage value. What is described above is the principle of the over-driving circuit.

The table checked by the LUT circuit 13 is an index matrix containing the over-driving voltage values and can replace complicated calculation or non-linear calculation with a database of constants; therefore, the complicated calculation is omitted, and the processing efficiency is promoted. The over-driving voltage values enable the segment electrodes 3 to output correct corresponding over-driving voltages V′. Thus, the response time of the traditional PM-LCD (such as TN LCD and STN LCD) adopting the APT driving method will be shortened, and the image streaking in dynamic pictures will be greatly reduced.

As PM-LCD (such as TN LCD and STN LCD) is a passive architecture, the pixel thereof has none switch element to keep the charge of the charged liquid crystal capacitor. After the segment electrode outputs voltage, the charge of liquid crystal capacitor will leak via the stray capacitor or the charging path. Therefore, the liquid crystal capacitance cannot maintain at a fixed level. After the segment electrode is charged for a frame time, the effective potential of the pixel capacitor is much smaller than that output by the segment electrode, and the blurring phenomenon thus occurs in dynamic pictures.

### SUMMARY OF THE INVENTION

The primary objective of the present invention to provide a driving method for reducing the response time of TN LCD and STN LCD, wherein an over-driving compensation method and a high-frequency refresh approach are used to shorten the response time of PM-LCD (such as TN LCD and STN LCD) and improve the blurring phenomenon of dynamic pictures.

To achieve the abovementioned objective, the present invention proposes a driving method for reducing the response time of TN LCD and STN LCD, wherein a dynamic picture judgment mechanism is arranged behind the RGB data (the primary three color data) bus and used to compare the current picture with the previous picture; if the pictures are different, a frequency-multiplication circuit flexibly outputs an over-driving compensation voltage N times within each refresh time of the data bus, and the over-driving compensation voltage is higher or lower than the original output voltage, and N is a positive integer greater than or equal to 2 but less than or equal to 8 (2□N□8). In general, the liquid crystal capacitor is charged by data voltage only once within a frame time. As the pixel of PM-LCD (such as TN LCD and STN LCD) has none switch element to keep the charge of the charged liquid crystal capacitor, the charge of liquid crystal capacitor will leak via the stray capacitor or the charging path. Therefore, after one frame time, the voltage of the liquid crystal capacitor cannot achieve the level expected by the input data bus. In the present invention, the output of an over-driving compensation voltage is repeated N times within a frame time; in other words, the pixel capacitor is charged N times within a frame time; and the over-driving compensation voltage is higher or lower than the original output voltage. Thereby, the molecules of liquid crystal are faster twisted to such an extent that the expected brightness appears. Thus, the blurring phenomenon occurring in PM-LCD (such as TN LCD and STN LCD) is greatly improved.

The over-driving compensation voltage V′ is a value corresponding to the original output voltage and obtained via a LUT (LookUp Table) operation. The over-driving compensation voltage V′ is greater than or equal to 0 but less than or equal to the maximum liquid crystal driving voltage.

Further, the RGB data (the primary three color data) may be transformed into YCbCr data according to the sampling and compressing rules of the video data compression standard, wherein the algorithm of Y:Cb:Cr=4:2:0 or Y:Cb:Cr=4:1:1 is used in the sampling and compressing operation of the present invention. Thereby, the amount of stored data was reduced to half.

### BRIEF DESCRIPTION OF THE DRAWINGS

FIG. 1 is a diagram schematically showing the architecture of an m×n PM-LCD.

FIG. 2 is a block diagram schematically showing the LUT operation of a general over-driving circuit.

FIG. 3 is a diagram schematically showing the waveform of the segment signal SEG within a frame time.

FIG. 4 is a diagram schematically showing the waveform of the segment signal SEG within a frame time, wherein a line time is divided into sixteen sections and the output voltage is scaled into levels.

FIG. 5 is a diagram schematically showing that the liquid crystal of a pixel twists and then shifts from the initial place to the target place.

FIG. 6 is a block diagram schematically showing the over-driving circuit according to one embodiment of the present invention.

FIG. 7 is a diagram schematically showing the comparison between the case that the segment electrode of the driving element writes in the display panel with the original refresh frequency and the case that the segment electrode of the driving element writes in the display panel with a frequency N times (6 times) the refresh frequency of the data-input bus.

FIG. 8 is a diagram schematically showing the comparison between the case that the segment electrode of the driving element writes in the display panel with the original voltage and with the original refresh frequency and the case that the segment electrode of the driving element writes in the display panel with an over-driving voltage and with a frequency N times (6 times) the refresh frequency of the data-input data bus.

FIG. 9 is a diagram schematically showing the waveform of the over-driving voltage output by the segment electrode, wherein a line time is divided into sixteen sections and the output voltage is scaled into levels.

FIG. 10 is a block diagram schematically showing the over-driving circuit according to another embodiment of the present invention.

FIG. 11 is a diagram schematically showing RGB data is transformed into YCbCr data according to the transformation of Y:Cb:Cr=4:2:0.

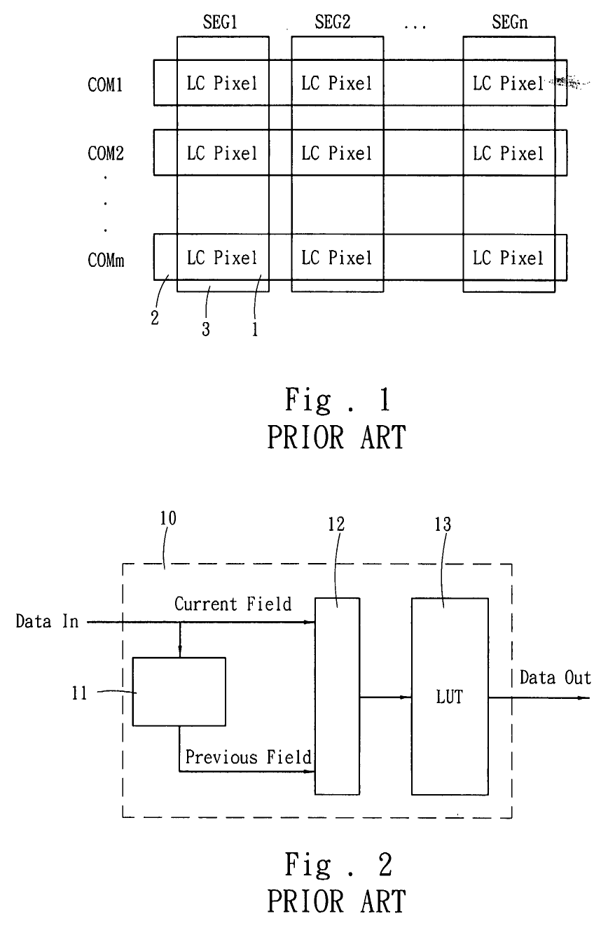

### DETAILED DESCRIPTION OF THE PREFERRED EMBODIMENTS

The technical contents of the present invention will be clarified with the embodiments. However, it is to be understood that those embodiments are not to limit the scope of the present invention but only to exemplify the present invention.

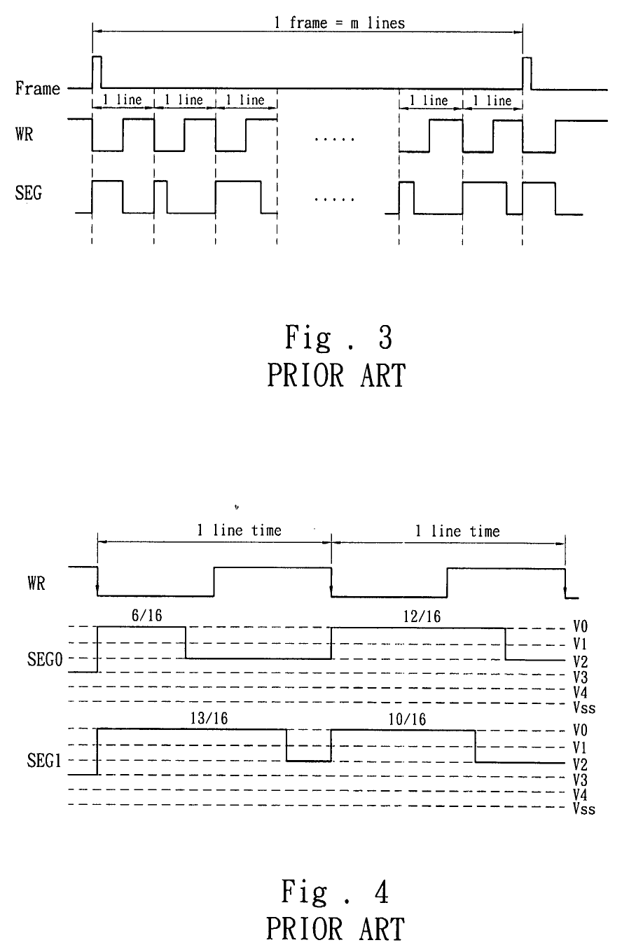

In the driving method of PM-LCD (such as TN LCD and STN LCD), the driving device outputs different gray-level voltages according to the input digital RGB data in each frame, and one gray-level voltage corresponds to one brightness value. TN LCD or STN LCD has only a black state and a white state. The gray level is generated with PWM (Pulse Width Modulation) in the time of one line. Refer to FIG. 3 a diagram schematically showing the waveform of the segment signal SEG within a frame time, wherein a frame time has m lines (for an m×n matrix type LCD), and a WR (write/read) period denotes a line time. From FIG. 3, the segment signal SEG has different PWM waveforms corresponding to different output gray-level voltages of the data.

Refer to FIG. 4, wherein a line time is divided into sixteen sections. In one specific line, the segment signal SEG0 has the all-black sections occupying six-sixteenth the line time; in the next line, the segment signal SEG0 has the all-black sections occupying twelve-sixteenth the line time. In one specific line, the segment signal SEG1 has the all-black sections occupying thirteen-sixteenth the line time; in the next line, the segment signal SEG1 has the all-black sections occupying ten-sixteenth the line time.

As PM-LCD (such as TN LCD and STN LCD) is a passive architecture, the pixel thereof has none switch element. After the segment electrode outputs voltage, the charge of liquid crystal capacitor will leak via the stray capacitor or the charging path. Therefore, the liquid crystal capacitance cannot maintain at a fixed level. After the segment electrode is charged for a frame time, the effective potential of the pixel capacitor is much smaller than that output by the segment electrode.

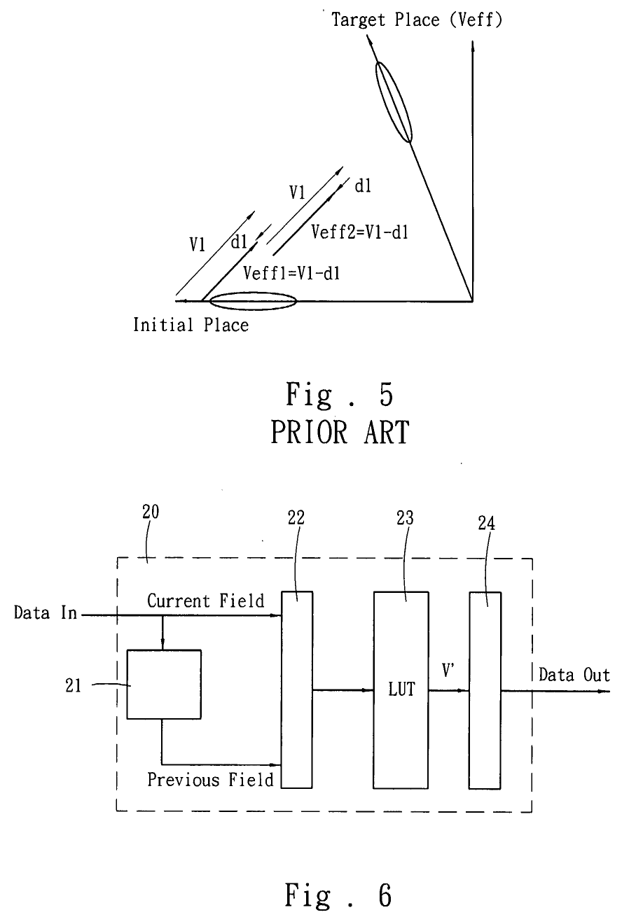

Refer to FIG. 5 a diagram schematically showing that the liquid crystal of a pixel twists and shifts from the initial place to the target place. The segment electrode has to charge the liquid crystal capacitor for several frame times before reaching the effective voltage Veff that can shift the liquid crystal of a pixel from the initial place to the target place. It is the reason why the response time of PM-LCD (such as TN LCD and STN LCD) is so slow. In FIG. 5, the segment electrode charges the liquid crystal capacitor with a voltage V1 in the first frame; however, the charge leaks via the stray capacitor or the charging path with a voltage decrease of d1; thus, the effective voltage for charging the liquid crystal capacitor in the first frame is V1−d1=Veff1. Similarly, the effective voltage for charging the liquid crystal capacitor in the second frame is V1−d1=Veff2. Suppose that the segment electrode has to send out the identical voltage twelve times to achieve the target brightness. Thus, the response time of the LCD is twelve times the frame time—16.67 ms×12, about 200 ms.

Refer to FIG. 6 a block diagram schematically showing the over-driving circuit according to one embodiment of the present invention. Similarly to the general over-driving method, the driving method of the present invention assigns different over-driving voltages V′ to different pictures. A picture-judgment circuit 20 utilizes a comparing device 22 to compare the current field with the previous field, which is stored in a storage device 21 inside or outside the driving device. If the pictures are different, they are dynamic pictures. Then, an LUT (LookUp Tible) circuit 23 looks up a table to determine an over-driving voltage value V′ corresponding to the data of the dynamic pictures and outputs the over-driving voltage value V′.

In the present invention, the comparing device 22 behind the data bus compares the input RGB data (the primary three color data). If the current picture is different from the previous picture, a frequency-multiplication circuit 24 behind the LUT circuit 23 flexibly outputs an over-driving compensation voltage V′ N times within each refresh time of the data bus. The over-driving compensation voltage V′ is higher or lower than the original output voltage V, and N is a positive integer greater than or equal to 2 but less than or equal to 8 (2□N□8). The over-driving compensation voltage V′ is a value corresponding to the original output voltage V and obtained via a LUT (LookUp Table) operation. The over-driving compensation voltage V′ is greater than or equal to 0 but less than or equal to the maximum liquid crystal driving voltage. The frequency that the segment electrode of the driving element writes in the display panel is N times the frequency that the RGB-input data bus refreshes.

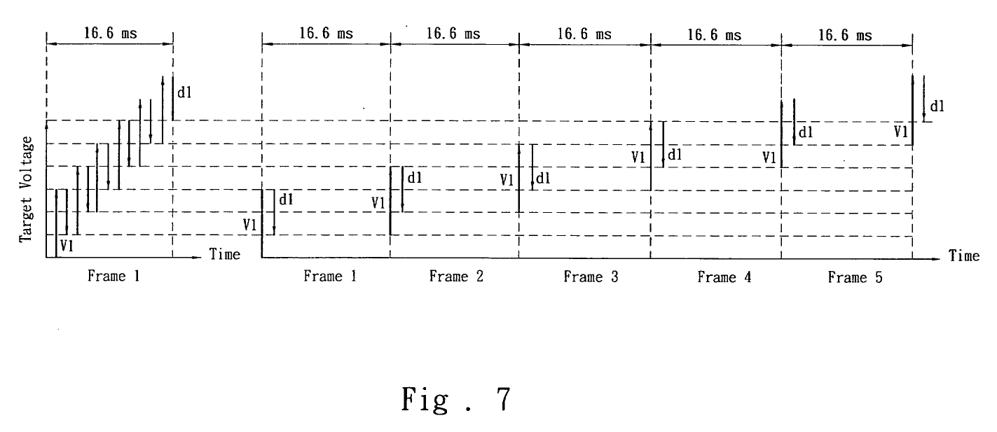

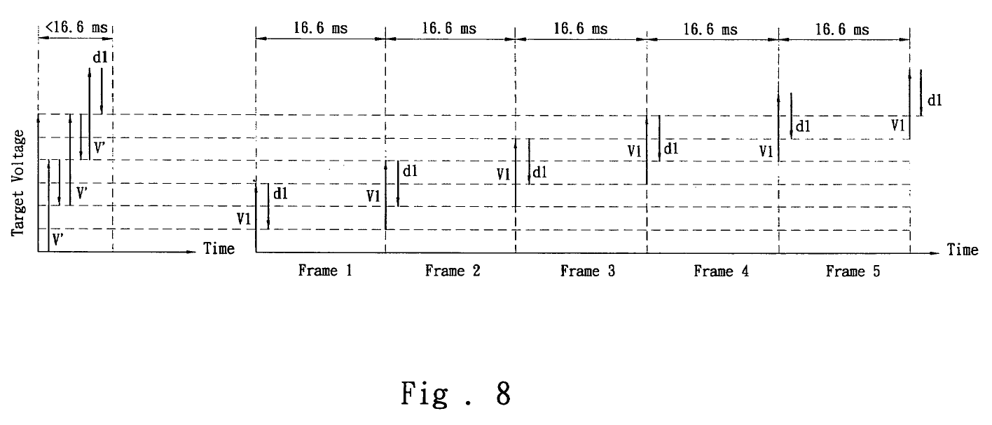

Refer to FIG. 7 a diagram schematically showing the comparison between the case that the segment electrode of the driving element writes in the display panel with the original refresh frequency and the case that the segment electrode of the driving element writes in the display panel with a frequency N times (6 times) the refresh frequency of the data-input bus. In the right part of FIG. 7, the segment electrode has to spend six frame times on outputting the identical voltage V1 to attain the target voltage by which the liquid crystal of a pixel shifts from the initial place to the target place. Thus, the response time in the right part of FIG. 7 is 16.6 ms×6—about 100 ms. In FIG. 7, d1 is the voltage drop resulting from the charge leakage via the leakage path of the pixel. In the left part of FIG. 7, the frequency-multiplication circuit 24 repeatedly outputs the original voltage V1 six times within a refresh time of the data bus (i.e. a frame time). Thus, the target brightness is attained within a frame time, and the response time is reduced to only a frame time 16.6 ms.

Refer to FIG. 8 a diagram schematically showing the comparison between the case that the segment electrode of the driving element writes in the display panel with the original voltage and with the original refresh frequency and the case that the segment electrode of the driving element writes in the display panel with an over-driving voltage and with a frequency N times (6 times) the refresh frequency of the data-input data bus. In the left part of FIG. 8, the output voltage V1 of the segment electrode is replaced by an over-driving voltage V′. Thus, the response time of PM-LCD (such as TN LCD and STN LCD) is further shortened to less than a frame time.

In the present invention, the segment electrode outputs an effective voltage, which is greater than (or less than) the original output voltage. Further, the effective voltage is repeatedly output many times within a data refresh time. Therefore, the liquid crystal can twist faster and the transmitted output brightness to attain the target brightness within a shorter time. Thus, the present invention can solve the problem of the blurring phenomenon resulting from too long response time of PM-LCD (such as TN LCD and STN LCD).

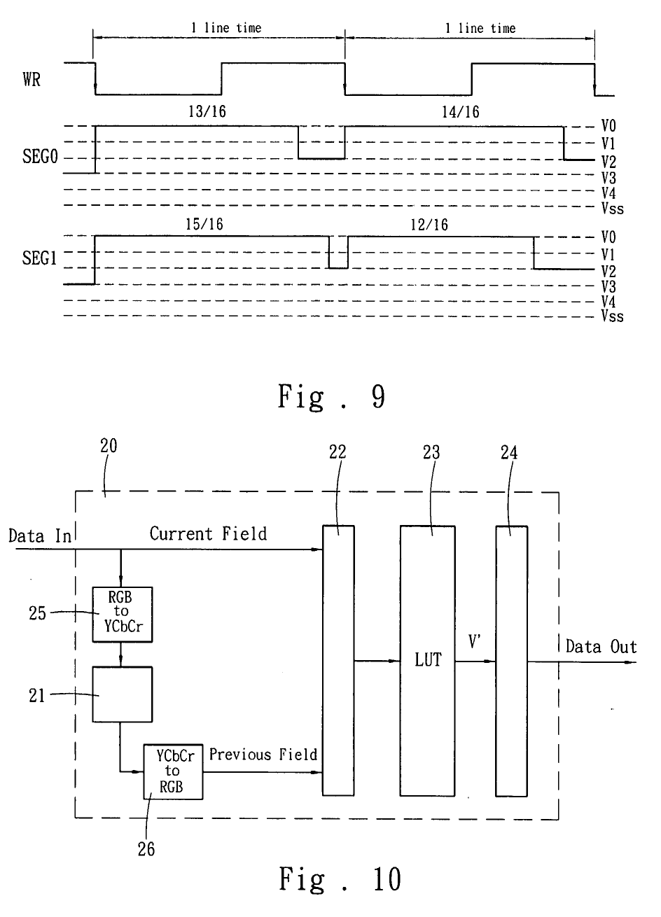

Refer to FIG. 9 a diagram schematically showing the waveform of the over-driving voltage output by the segment electrode, wherein the over-driving voltage is obtained via over-driving the waveform of FIG. 4. In one specific line, the segment signal SEG0 has the all-black sections occupying thirteen-sixteenth the line time; in the next line, the segment signal SEG0 has the all-black sections occupying fourteen-sixteenth the line time. In one specific line, the segment signal SEG1 has the all-black sections occupying fifteen-sixteenth the line time; in the next line, the segment signal SEG1 has the all-black sections occupying twelve-sixteenth the line time.

The liquid crystal of a pixel can twist and then shift from the initial place to the target place and attain the target brightness of the effective voltage Veff within a shorter time via the approach that the segment electrode outputs an over-driving compensation voltage N times within each data refresh time. Thus, the present invention can greatly improve the blurring phenomenon of dynamic pictures. PM-LCD (such as TN LCD and STN LCD) is driven with the APT method, wherein the electro-optical effect of liquid crystal, which is generated by the RMS (Root Mean Square) values of the applied voltage, is used in the operation of PM-LCD (such as TN LCD and STN LCD). The RMS value of the over-driving compensation voltage will not result in serious flicker.

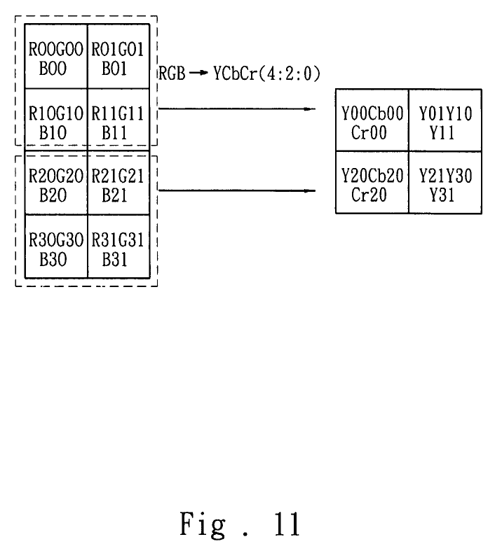

The over-driving compensation method needs an extra GRAM (Graphic Random Access Memory) to store the data of the previous picture, which is to be compared with the current picture. Alternatively, the RGB data can be sampled and synthesized according to the video compression standard and then transformed into YCbCr data. Refer to FIG. 10 a block diagram schematically showing the over-driving circuit according to another embodiment of the present invention. A first transformation unit 25 receives the RGB data of the previous picture and transforms the RGB data into YCbCr data. Refer to FIG. 11. The transformation of Y:Cb:Cr=4:2:0 or Y:Cb:Cr=4:1:1 is used in the sampling and compressing operation of the present invention. The YCbCr data is stored in the storage device 21 inside or outside the driving device. A second transformation unit 26 transforms the YCbCr data into the RGB data and transmits the RGB data to the comparing device 22. In YCbCr data, Y denotes luminance, and Cb and Cr denote color difference. Among the Y, Cb, and Cr signals, the Y component has the highest influence on human vision. The Y component is sampled and compressed according a sampling ratio to reduce the memory requirement. Thereby, the data needing storage is reduced to half. Consequently, the data of the previous picture and the data processed by the over-driving compensation method can be together stored in a GRAM inside the original driving device, and no extra GRAM is needed.

Those described above are the preferred embodiments to exemplify the present invention. However, it is not intended to limit the scope of the present invention. Any equivalent modification and variation according to the specification and claims of the present invention is to be also included within the scope of the present invention.

What is claimed is:

1. A driving method for reducing the response time of twisted nematic liquid crystal displays and super twisted nematic liquid crystal displays, comprising:
based on the principle of over-driving operation, a dynamic picture judgment mechanism being arranged behind the RGB data (the primary three color data) bus and used to compare the current picture with the previous picture; if said current picture being different from said previous picture, a frequency-multiplication circuit flexibly outputting an over-driving compensation voltage N times within each refresh time of the data bus, and said over-driving compensation voltage being higher or lower than the original output voltage, and N being a positive integer greater than or equal to 2 but less than or equal to 8.

2. The driving method according to claim 1, wherein via an LUT (LookUp Table) operation, the over-driving circuit looks up a table and outputs different over-driving compensation voltages for different pictures, and said over-driving compensation voltage is greater than or equal to 0 but less than or equal to the maximum liquid crystal driving voltage.

3. The driving method according to claim 1, wherein RGB data is transformed into YCbCr data according to the video compression transformation standard.

4. The driving method according to claim 3, wherein RGB data is sampled and compressed to obtain YCbCr data according to the transformation of Y:Cb:Cr=4:2:0 or Y:Cb:Cr=4:1:1.
